(19) United States
(12) Patent Application Publication
(10) Pub. No.: US 2014/0010958 A1
(43) Pub. Date: Jan. 9, 2014

(54) DEVICE FOR GENERATING SOLID HYDROGEN- AND/OR DEUTERIUM-BASED TARGETS

(71) Applicant: COMMISSARIAT A L'ENERGIE ATOMIQUE ET AUX ENERGIES ALTERNATIVES, Paris (FR)

(72) Inventor: Jean-Paul PERIN, Seyssins (FR)

(21) Appl. No.: 13/935,833

(22) Filed: Jul. 5, 2013

(30) Foreign Application Priority Data
Jul. 6, 2012 (FR) 12 01923

(51) Int. Cl. C01B 3/00; C01B 4/00

(52) U.S. Cl. CPC C01B 3/0094; C01B 4/00
USPC 427/255.395; 118/724; 427/255.5

(57) ABSTRACT

The device for performing continuous deposition of a solid hydrogen and/or deuterium film includes a cell provided with a control valve for controlling the flowrate of the gas inlet to the cell, a strip, and means for moving the strip in the cell. The device includes a pumping device placing a volume of the cell, through which the strip passes, at a first pressure, and a heat exchanger arranging the strip in said volume at a first temperature. To adjust the pressure, the device further includes a control circuit of the pumping device and of the control valve, adjusting the first pressure so as to condense a solid hydrogen and/or deuterium film on the strip in movement in said volume.

### BACKGROUND OF THE INVENTION

The invention relates to a device for producing solid hydrogen and/or deuterium targets continuously and at cryogenic temperatures.

### STATE OF THE ART

Recent progress made by high-power lasers enables use of the latter to be envisaged in several fields, in particular in fields using a proton beam. For example, protontherapy is a particular radiotherapy technique the aim of which is to destroy cancerous cells by irradiating them with a proton beam.

The protons can be accelerated by focusing a high-intensity pulsed laser on a target comprising pure solid hydrogen and/or deuterium, at a frequency of about 10 Hz.

It is therefore interesting to provide a system continuously producing a solid hydrogen and/or deuterium film having a small thickness (1 to 10 μm), deposited on a gold or aluminium strip. By using this type of strip, the protons, mainly originating from the solid hydrogen and/or deuterium film, can be accelerated by the intense electric field generated by interaction of an intense laser with the gold or aluminium strip.

Formation of solid hydrogen and/or deuterium films is generally performed on gold or silver foil sheets. The article [“Experimental setup for X-ray spectroscopy of muonic atoms formed from implanted ions in solid hydrogen”—P. Strasser and al. —Nuclear Instruments and Methods in Physics Research A, 460 (2001), pp. 451-456] describes an X-ray spectrometer emitted by muonic atoms. In this device, the muonic atoms are generated by ion implantation in a solid hydrogen film. The spectrometer comprises a cryogenic chamber comprising a support of a silver strip and a diffuser of a gas mixture having a hydrogen and deuterium base. The pressure and volume of the gas mixture inlet to the diffuser produce a dosed distribution of the gas mixture on the silver strip. Maintaining the silver strip at a temperature of 3 K and dosed distribution of the hydrogen and deuterium gas mixture thereby enable formation of a solid hydrogen film on the silver strip.

Interaction of a laser with solid targets can be used in other fields, for example in extreme ultraviolet lithography (13.5 nm wavelength). In the article [“Laser-Plasma Extreme Ultraviolet Source Incorporating a Cryogenic Xe Target”—S. Amano—Recent Advances in Nanofabrication Techniques and Applications, December (2011), pp. 353-368], Laser-Produced Plasma (LPP) constitutes the source of the extreme ultraviolet beam. This article describes a device using Xe as solid target for creation of the LPP plasma. Indeed, Xe enables a strong emission around 13.5 nm. In addition, as Xe is an inert gas, it prevents deposition of residues. The device comprises a cylindrical copper drum filled with liquid nitrogen designed to cool the outer surface of the drum. The Xe in gas phase is then injected onto the outer surface of the cylindrical drum in rotation. The Xe in gas phase thus condenses to form a solid film of Xe with a thickness ranging from 300 to 500

### OBJECT OF THE INVENTION

In certain applications, a requirement exists to provide a device for continuous deposition of a solid hydrogen and/or deuterium film on a strip that is easy to produce and to use.

This requirement tends to be satisfied by providing a device for performing continuous deposition of a film of solid hydrogen or deuterium, or of a mixture of the two, comprising:
a cell provided with first and second openings, and with an input opening for inlet of the hydrogen and/or deuterium in gas phase, the flowrate of the gas inlet to the cell being adjusted via a control valve;
a strip passing through the cell via the first and second openings;
movement means of the strip configured to move the strip in the cell from the first opening to the second opening;
a pumping device configured to place a volume of the cell, through which the strip passes, at a first pressure;
a first heat exchanger configured to maintain the strip in said volume of the cell at a first cryogenic temperature;
a control circuit of the pumping device and of the control valve configured to adjust the first pressure to a higher value than the value of the saturated steam pressure of the hydrogen or deuterium or of the mixture, at the first cryogenic temperature, so as to respectively condense a solid hydrogen and/or deuterium film on the strip in movement in said volume of the cell.

A method is also provided for continuous deposition of a solid hydrogen or deuterium film comprising the following steps:
running a strip through a cell from a first opening to a second opening;
injecting a gas formed by hydrogen or deuterium or a mixture of the two into the cell, the strip being maintained in a volume of the cell at a first cryogenic temperature, and the gas being at a first pressure in the cell, said first pressure being adjusted to a first value lower than the saturated steam pressure of the gas at the first temperature;
increasing the first pressure of the gas in said volume of the cell from the first value to a second pressure value that is higher than the saturated steam pressure of the gas at the first temperature.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 schematically represents a device for producing a solid hydrogen or deuterium film on a strip, in continuous manner;

FIG. 2 represents another embodiment of a device for producing a solid hydrogen or deuterium film on a strip, in continuous manner;

FIG. 3 represents the phase diagram of hydrogen.

### DESCRIPTION OF PARTICULAR EMBODIMENTS

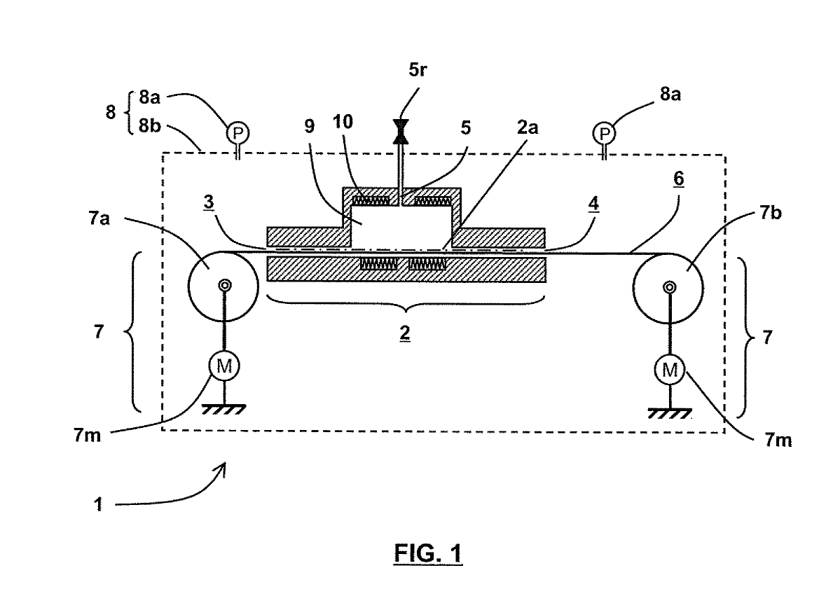

As represented in FIG. 1, a device 1 for performing continuous deposition of a film of solid hydrogen or deuterium, or a mixture of the two, comprises a cell 2 extending along a longitudinal axis 2a. Cell 2 is provided with first and second openings 3 and 4 and with an inlet opening 5 of the hydrogen or deuterium or of a mixture of the two, in gas phase. First opening 3 is advantageously located at the level of a first end of cell 2, and second opening 4 is advantageously located at the level of a second end opposite the first end along longitudinal axis 2a. Device 1 further comprises a control valve 5r configured to control a flowrate provided by the inlet opening 5. In other words, the control valve 5r is designed to adjust the flowrate of the gas inlet to cell 2.

Device 1 also comprises a strip 6 on which a solid film of hydrogen and/or deuterium is advantageously deposited in continuous manner. Strip 6 is a metal strip and it is preferably gold- or aluminium-based. What is meant by continuous deposition of a film on strip 6 in cell 2 is that device 1 enables a film to be deposited on strip 6 whereas it is moving inside cell 2. Strip 6 is passing through the cell 2 via first 3 and second 4 openings. Furthermore, strip 6 is configured to move in cell 2 from the first opening to the second opening. This movement does not exclude provisional stopping of strip 6 being performed in cell 2.

Device 1 further comprises movement means 7 configured to perform movement of strip 6 in cell 2 from first opening 3 to second opening 4. Movement means 7 can comprise a first fixed reel 7a and a second fixed reel 7b around which strip 6 can be wound. First reel 7a can be located at the level of first opening 3. Second reel 7b can thus be located at the level of second opening 4 so that cell 2 is arranged between first reel 7a and second reel 7b. The location of first 7a and second 7b reels is chosen so as to be able to move strip 6 in cell 2. Movement means 7 can comprise a motor 7m designed to make second reel 7b rotate around its axis so as to unwind strip 6 from first reel 7a and to wind it around second reel 7b. Advantageously, motor 7m also enables first reel 7a to rotate and to perform movement of strip 6 in the opposite direction, i.e. from second opening 4 to first opening 3. Another motor can also be associated with first reel 7a.

In general manner, condensation of a gas at cryogenic temperatures requires precise adjustment of the pressure and temperature of the gas that is to be condensed. However, depending on the configuration of cell 2, control valve 5r cannot on its own maintain a constant pressure of the gas inlet to cell 2. The gas inlet via opening 5 can in fact escape from cell 2 through first and second openings 3 and 4. For this reason, to adjust the pressure of the gas to be condensed, device 1 further comprises a pumping device 8 configured to place a volume 9 of cell 2 at a first pressure P1. Said volume 9 is defined in cell 2 and strip 6 runs through the latter.

The pumping device can comprise one or more pumps 8a and a sealed chamber 8b containing cell 2 and strip 6. Pumping device 8 further enables any parasitic condensation of the gas outside said volume 9 to be prevented, by sucking the gas escaping from cell 2.

Cell 2 also comprises a first heat exchanger 10 configured to maintain strip 6 in said volume 9 of the cell at a first cryogenic temperature T1. What is meant by cryogenic temperatures are temperatures lower than about 120 K. First heat exchanger 10 is preferably located in the walls of cell 2 so as to be in contact with the molecules of the gas inlet to cell 2. For simplification reasons, in the remainder of the text, first heat exchanger 10 will also designate the part of cell 2 defining said volume 9 of the cell. The contact between the molecules of the gas and first heat exchanger 10 enables the temperature of the gas comprised in said volume 9 to be easily adjusted. Heat exchanger 10 is preferably controlled by a thermostat. On account of the molecular heat exchange phenomenon between gas and strip 6, heat exchanger 10 thus enables strip 6 and the gas inlet to said volume 9 of the cell to be maintained at the first cryogenic temperature T1. For continuous deposition of a solid hydrogen film on strip 6, the inlet gas is a hydrogen gas and the first temperature T1 is preferably equal to 7 K. For continuous deposition of a solid deuterium film on strip 6, the inlet gas is a deuterium gas and the first temperature T1 is preferably equal to 12 K.

Device 1 is able to define the temperature of the gas and of strip 6 in cell 2 by means of first heat exchanger 10. In order to also define the pressure, device 1 comprises a control circuit of pumping device 8 and of control valve 5r. Said control circuit is configured to adjust the first pressure P1 to a value P1c. The pressure value P1c is higher than the value of the saturated steam pressure Ps of the material to be deposited, at the first cryogenic temperature T1. This adjustment of the first pressure P1, is performed so as to respectively condense a solid film of hydrogen or deuterium or of a mixture of the two, on strip 6 in movement in said volume 9 of the cell. Advantageously, adjustment of the first pressure P1 by the control circuit also depends on the speed of movement of strip 6 in said volume 9 of the cell and on the thickness of the solid film that is to be condensed on strip 6.

Device 1 enables a film of solid hydrogen or deuterium to be deposited on a moving metal strip. The metal strip can then be bombarded by a laser beam, preferably a pulsed laser beam, thereby generating a proton beam due to the interaction of the laser with the metal strip. In order to generate the proton beam, the laser interacts directly with the metal strip to generate a gold or aluminium plasma with a high electronic density. The solid hydrogen or deuterium film is thus preferably arranged on one of the two main surfaces of the strip only. The laser then bombards the surface devoid of a solid hydrogen and/or deuterium film. The intense electric field generated by the metal laser interaction enables protons located at the level of the surface of the strip comprising the solid hydrogen and/or deuterium film to be accelerated.

Device 1 according to the first embodiment enables a solid film of hydrogen and/or deuterium to be condensed on the two main surfaces of strip 6 in said volume 9 of cell 2. Consequently, to prepare strip 6 for a possible interaction with a laser beam, device 1 can comprise means designed to eliminate the condensed film on one of the two main surfaces of strip 6. For example purposes, device 1 can comprise a scraper, not represented in FIG. 1, arranged downstream from cell 2 in the direction of movement of strip 6. Said scraper is shaped and placed so as to eliminate the condensed film of solid hydrogen or deuterium on one of the two main surfaces of strip 6.

Continuous deposition of a film of solid hydrogen or deuterium on a metal strip facilitates continuous generation of a proton beam. In advantageous manner the device can be configured so that the speed of movement of strip 6 is chosen according to the frequency of the pulsed laser bombarding strip 6. For example purposes, by using first 7a and second 7b reels which have a diameter of 40 mm, and a speed of movement of strip 6 of 5 mm/s, device 1 enables continuous production, during 24 hours, of a strip comprising a solid hydrogen film with a thickness of about 5 μm.

First heat exchanger 10 is preferably configured to be in contact with a main first surface 6a of strip 6. For example purposes, the elements enabling heat transfer with first heat exchanger 10 can be arranged salient with respect to the walls of cell 2 so as to be in contact with strip 6 when the latter passes through cell 2. The contact between first heat exchanger 10 and strip 6 enables a direct heat transfer to be performed between these two elements. Definition of the temperature of strip 6 is thereby more precise and the heat transfer is faster in comparison with a heat transfer performed by means of the hydrogen or deuterium gas comprised between first heat exchanger 10 and strip 6. Furthermore, first heat exchanger 10 also enables a heat transfer to be performed to the molecules of the gas contained in said volume 9.

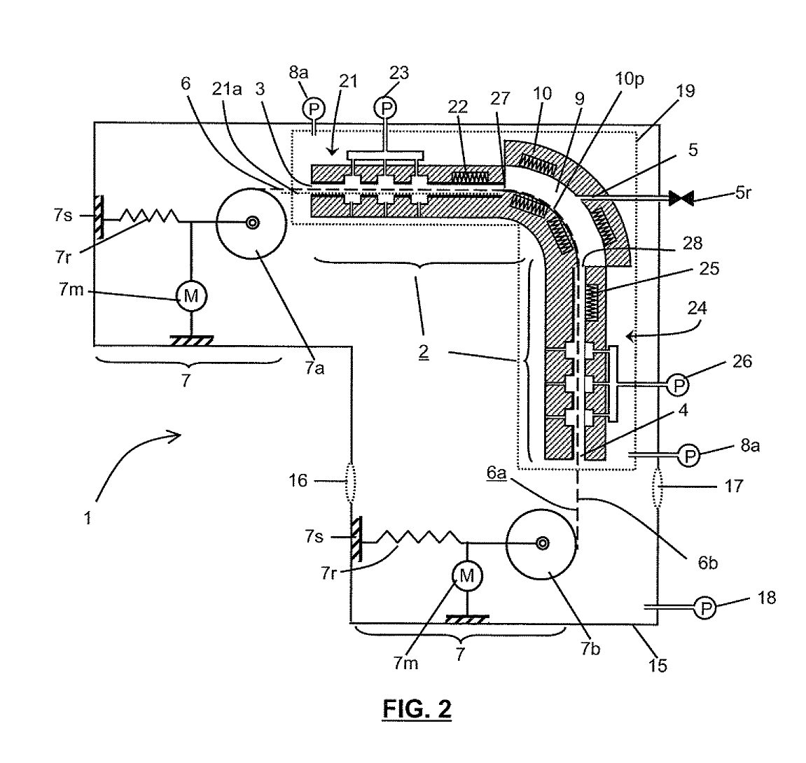

According to a second embodiment illustrated in FIG. 2, first heat exchanger 10 and cell 2 are configured to be in contact with main surface 6a of strip 6, in said volume 9 of the cell, so as to achieve condensation of the solid hydrogen or deuterium on a second surface 6b only. Second surface 6b is opposite to the main surface 6a of strip 6. Device 1 of FIG. 2 comprises similar elements to those illustrated in FIG. 1, designated by the same reference numerals. The following are in particular to be found, movement means 7, strip 6, and cell 2 provided with first opening 3 and second opening 4 and comprising volume 9 through which strip 6 passes. First heat exchanger 10 and pumping device 8 are also to be found. First heat exchanger 10 preferably comprises an inner wall 10p having the shape of a convex curve. This inner wall 10p is shaped so as to be in contact with main surface 6a of strip 6 when the latter passes through said volume 9 of the cell.

Device 1 for performing continuous deposition according to this embodiment enables an efficient heat transfer to be achieved between first heat exchanger 10 and strip 6. Device 1 further enables a solid hydrogen and/or deuterium film to be deposited on main surface 6a of metal strip 6, leaving the opposite surface 6b of strip 6, designed to interact with a laser beam, uncovered.

In advantageous manner, movement means 7 are mechanically connected to a fixed support 7s by means of at least one spring 7r so as to fix the tension of strip 6, and the contact pressure between the strip 6 and first heat exchanger 10 in said volume 9 of the cell. Spring 7r can thus adjust a contact pressure between the strip 6 and inner wall 10p of first heat exchanger 10, which enables the heat transfer from the heat exchanger to strip 6 to be improved. Spring 7r also makes it possible to maintain a fixed tension of strip 6 during movement of the latter in cell 2, in particular when it is wound and unwound around reels 7a and 7b. In other words, the device 1 comprises at least one spring 7r mechanically connected to a fixed support 7s so as to fix the tension of the strip 6 and the contact pressure of the strip on the first heat exchanger 10 in said volume 9 of the cell 2. Maintaining a selected tension then makes it possible to avoid excessive stretching of strip 6 able to be the cause of deformation or even worse to result in breaking of metal strip 6.

In order to take account of a possible interaction between a laser beam and opposite surface 6b of strip 6, device 1 advantageously comprises a tightly sealed cryostat 15 inside which cell 2 and strip 6 are located. Cryostat 15 is shaped in such a way as to comprise a first window 16 configured to let an incident laser beam bombarding strip 6 pass, and a second window 17 configured to let the proton or neutron beam transmitted by strip 6 pass. For example, first window 16 can Sapphire-based and second window 17 can be Mylar-based. To achieve an efficient interaction between laser beam and strip 6 only, cryostat 15 also comprises an additional pump 18 configured to create a vacuum in the tightly sealed cryostat 15. The vacuum created within the cryostat prevents any parasitic condensation of the gas on opposite surface 6b of level strip 6 that might disturb interaction of the laser with metal strip 6.

For an improved thermal insulation between cell 2 and movement means 7, device 1 can comprise a heat shield fitted between these two elements. In other words, device 1 advantageously comprises a heat shield 19 separating movement means 7 and cell 2. Movement means 7 do in fact comprise mechanical parts maintained at 300 K which generate heat inputs by radiation. In the absence of a heat shield, these heat inputs may disturb the thermal stability of cell 2, and thereby condensation of the gas on strip 6. Preferably, the device 1 comprises a heat shield covering the cell 2, and comprising two apertures facing respectively the first and second openings. The said apertures configured to let the strip moving through the cell 2 via the first and second openings.

In advantageous manner, cell 2 comprises an upstream duct 21 arranged between first opening 3 and first heat exchanger 10 and extending along a longitudinal axis 21a. Upstream duct 21 is shaped in such a way that strip 6 passes through the duct when movement of the latter takes place in cell 2. Strip 6 thus respectively passes through first opening 3, upstream duct 21, and then first heat exchanger 10 when strip 6 moves in cell 2 from first opening 3 to second opening 4. Strip 6 preferably passes through upstream duct 21 in a direction that is identical to longitudinal axis 21a. Upstream duct 21 is connected to said volume 9 of the cell so as to form a first outlet opening 27 of the non-condensed gas on strip 6. In advantageous manner, cell 2 also comprises a second heat exchanger 22 preferably located in the walls of upstream duct 21. Second heat exchanger 22 is configured to keep strip 6 in upstream duct 21 at a second temperature T2 that is higher than first temperature T1. Second temperature T2 is fixed so as to maintain the hydrogen or deuterium gas, inlet to cell 2, in gas phase in upstream duct 21.

Upstream duct 21 enables strip 6 to be thermally prepared before passing into said volume 9 of the cell. Strip 6 is in fact initially wound around first and second reels 7a and 7b, which operate at a higher temperature, for example at a temperature close to the ambient temperature (about 300 K). Second heat exchanger 22 of upstream duct 21 enables the temperature of strip 6 to be lowered and maintained at second temperature T2, preferably close to first temperature T1. Upstream duct 21 thus enables first heat exchanger 10 to maintain the temperature of strip 6 in said volume 9 in rapid and precise manner, which improves the efficiency of condensation of the solid hydrogen and/or deuterium on strip 6.

In preferential manner, movement means 7 are configured for strip 6 to be devoid of contact with second heat exchanger 22 in upstream duct 21. Strip 6 being in contact with first heat exchanger 10, this arrangement enables any additional friction between strip 6 and cell 2 to be prevented. Indeed, repetitive friction may result in wear and mechanical fatigue of metal strip 6. The heat transfer between second heat exchanger 22 and strip 6 is then performed by molecular heat exchange. The latter is performed using flow of the non-condensed hydrogen and/or deuterium gas from first outlet opening 27 to first opening 3, via upstream duct 21. This gas flow is made possible by means of pumping device 8 which participates in regulating the pressure of the gas to be condensed in cell 2 and in particular in said volume 9 of the cell. To achieve a better control of this pressure, pumping device 8 advantageously comprises a first pump 23 configured to perform suction of the non-condensed excess gas flowing in upstream duct 21 downstream from second heat exchanger 22. First pump 23 is preferably arranged between first opening 3 and second heat exchanger 22. First pump 23 is connected to upstream duct 21 via one or more openings formed in an area of the inner walls of upstream duct 21. In advantageous manner, said area of the inner walls is formed by chicanes, thereby improving the aerodynamics of the gas when the latter is sucked in by first pump 23.

Cell 2 advantageously comprises a similar downstream duct 24 to upstream duct 21. Downstream duct 24 is arranged between first heat exchanger 10 and second opening 4, and it is formed in such a way that strip 6 passes through the latter when movement of the strip takes place in cell 2. Downstream duct 24 is connected to said volume 9 of the cell so as to form a second outlet opening 28 of the non-condensed gas on strip 6. In advantageous manner, cell 2 also comprises a third heat exchanger 25, preferably arranged in the walls of downstream duct 24. Third heat exchanger 25 is configured to maintain strip 6 in downstream duct 24 at a third temperature T3 that is higher than first temperature T1. Third temperature T3 is fixed so as to maintain the hydrogen or deuterium gas, inlet to cell 2, in gas phase in downstream duct 24. Second temperature T2 and third temperature T3 are preferably substantially equal.

Downstream duct 24 advantageously enables condensation of solid hydrogen and/or deuterium on strip 6 to be stopped, while at the same time maintaining thermodynamic conditions compatible with maintaining the hydrogen and/or deuterium film in solid state on strip 6.

In preferential manner, movement means 7 are configured for strip 6 to be devoid of contact with third heat exchanger 25 in downstream duct 24. The heat transfer between third heat exchanger 25 and strip 6 is performed by molecular heat exchange. The latter is performed by making use of flow of the non-condensed hydrogen and/or deuterium gas between second outlet opening 28 and second opening 4, via downstream duct 24. For better control of the pressure of the gas in cell 2, pumping device 8 advantageously comprises a second pump 26 configured to perform suction of the non-condensed excess gas flowing in downstream duct 24. Second pump 26 is preferably arranged between second opening 4 and third heat exchanger 25. Second pump 26 is connected to downstream duct 24 via one or more openings formed in an area of the inner walls of downstream duct 24. Said area of the inner walls is preferably formed by chicanes.

According to a particular implementation mode of continuous deposition of a solid hydrogen and/or deuterium film on a metal strip, the deposition method uses one of the devices illustrated in FIGS. 1 and 2. The continuous deposition method according to the invention comprises a step enabling a metal strip 6 to be made to run in a cell 2 from a first opening 3 to a second opening 4. The deposition of the solid hydrogen and/or deuterium film is performed at very low temperature, for example at a temperature comprised between 5 K and 20 K, preferably between 7 K and 12 K. Strip 6 preferably moves in continuous manner inside cell 2, either in one direction or in the other, to prevent any sticking of strip 6 on the cold parts of deposition device 1.

The deposition method further comprises a step of injection of a gas formed by hydrogen or deuterium in cell 2. During this gas injection step, strip 6 is maintained in a volume 9 of the cell at first cryogenic temperature T1. The gas is further maintained at a first pressure P1 in cell 2. During this injection step, the first pressure P1 is adjusted so as to have a first value P1i that is lower than the saturated steam pressure Ps of the gas at first temperature T1.

In order to condense the gas on metal strip 6, the deposition method comprises a step of increasing the first pressure P1 of the gas in said volume 9. After injection of the gas in said volume 9 of the cell has been performed, first pressure P1 of the gas is in fact increased from the first value P1i to a second pressure value P1c. The second pressure value P1c of the gas in said volume 9 is chosen so as to be higher than the saturated steam pressure Ps of the gas to be condensed, at first temperature T1.

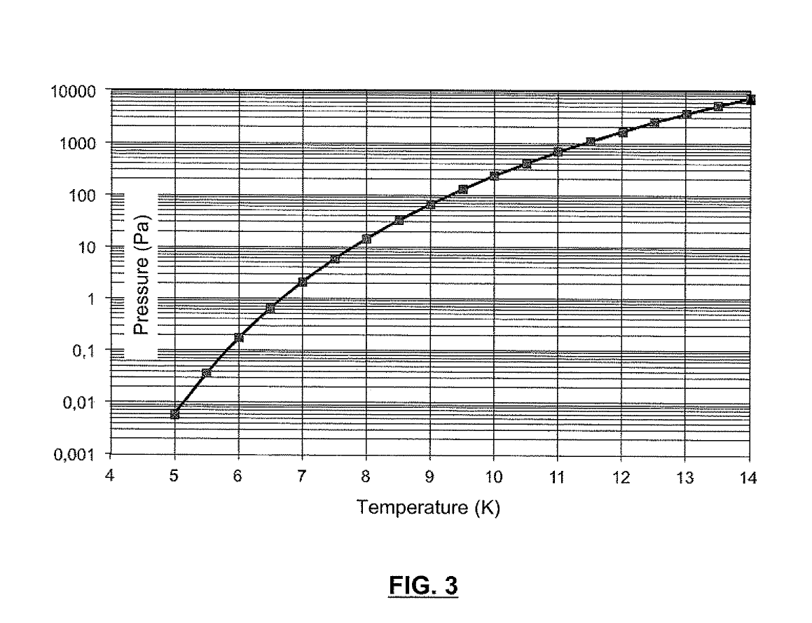

FIG. 3 illustrates the plot of the hydrogen gas saturation curve representing the variation of the saturated steam pressure Ps(T) versus temperature. According to this saturation curve, the saturated steam pressure of the hydrogen at a temperature of 7 K is equal to about 2 Pa. For a solid hydrogen deposition, by setting the first temperature T1 at 7 K, the first pressure P1 has to be less than 2 Pa during the injection step. By maintaining the first pressure P1 of the gas in cell 2, for example at 1 Pa, the hydrogen gas in fact remains in gas phase during the injection step. To achieve condensation of the hydrogen, the pressure of the hydrogen in the cell simply has to be increased, in particular in said volume, from 1 Pa to a second pressure P2 of more than 2 Pa, for example to 10 Pa. According to the saturation curve of FIG. 3, when this pressure increase is performed, the hydrogen gas goes from gas phase to solid phase. Second 22 and third 25 heat exchangers are preferably configured so as to maintain the temperature in upstream and downstream duct 21 and 24 equal to about 8 K. Indeed, according to the saturation curve plot illustrated in FIG. 3, the hydrogen remains in gas phase during the injection step (P1=1 Pa, and T2=T3=8 K) as well as in the condensation step (P1=10 Pa, and T2=T3=8K).

The continuous deposition method according to the invention advantageously enables the constraint on the temperature parameter to be released in order to focus only on the “gas pressure” parameter when condensation takes place. Stabilization of the temperature of the strip and of the gas to be condensed can in fact prove more delicate than adjustment of the pressure of the gas in the condensation cell. The method according to the invention thus facilitates continuous condensation of a solid hydrogen and/or deuterium film on a metal strip.

According to a preferred implementation mode, the continuous deposition method uses device 1 illustrated in FIG. 2. The method preferably comprises a first step where additional pump 18 creates a vacuum in cryostat 15. For example purposes, additional pump 18 maintains the pressure within cryostat 15 at about 10⁻⁴ Pa. Movement means 7 are then configured to impose a to-and-fro movement of metal strip 6. At the same time, first heat exchanger 10 maintains strip 6 at the first temperature T1. The gas to be condensed is then injected into said volume 9 of the cell. Injection of the gas in said volume is performed after stabilization of the temperature of the strip at the first temperature T1. Pumping device 8, comprising the two pumps 8a and first and second pumps 23 and 26, is then adjusted to maintain the gas in cell 2 at a first pressure P1, having a lower first value P1i than the saturated steam pressure Ps of the gas to be condensed at the first temperature T1. The gas therefore does not condense on metal strip 6 and remains in gas phase. Due to pumping device 8, the gas to be condensed does not escape from cell 2 to cryostat 15, which enables cryostat 15 to be maintained at a constant pressure and the quality of the vacuum in cryostat 15 to be preserved. Furthermore, in the case where an infinitely small quantity of gas escapes suction, additional pump 18 removes this quantity of gas to prevent any parasitic condensation of the gas outside cell 2.

Injection of the gas in cell 2 and adjustment of second 22 and third 25 heat exchangers enable strip 6 to be maintained at second T2 and third T3 temperatures, respectively in upstream duct 21 and downstream duct 24. These heat exchangers in fact take advantage of flow of the gas between said volume 9 and upstream and downstream ducts 21 and 24 to cool the strip by molecular heat exchange. Second and third temperatures T2 and T3 are chosen such as to be close to first temperature T1 and to maintain the gas to be condensed in gas phase in upstream and downstream ducts 21 and 24.

When the temperature of strip 6 and of the gas in said volume 9 is stabilized (equal to T1), the control circuit of pumping device 8 and of control valve 5r is configured to increase the pressure of the gas in said volume 9 from first value P1i to a second pressure value P1c that is higher than the saturated steam pressure Ps of the gas to be condensed at the first temperature T1. This pressure increase then enables a solid hydrogen and/or deuterium film to be deposited on strip 6 in movement in said volume 9 of the cell. The control circuit adjusts the first pressure P1 according to the gas involved (hydrogen or deuterium), the speed of movement of strip 6 in said volume 9 and the thickness of the layer to be deposited on strip 6.

Advantageously, the deposition method comprises a final step consisting in heating cell 2 and cryostat 15, for example to a temperature of 25 K. This heating enables all the undesirable condensates in cell 2 and in cryostat 15 to be removed in order to prepare the deposition device for a new in condensation of hydrogen and/or deuterium on metal strip 6.

1. A device for performing continuous deposition of a film of solid hydrogen or deuterium, or of a mixture of the two, comprising:
a cell provided with first and second openings, and with an inlet opening of the hydrogen and/or deuterium or of the mixture in gas phase into the cell; the flowrate of the gas inlet to the cell being adjusted via
a control valve configured to control a flowrate provided by the inlet opening;
a strip passing through the cell via the first and second openings, the strip being configured to move in the cell from the first opening to the second opening;
at least one pump configured to place a volume of the cell, through which the strip passes, at a first pressure;
a first heat exchanger configured to maintain the strip in said volume of the cell at a first cryogenic temperature;
a control circuit of the at least one pump and of the control valve configured to adjust the first pressure to a higher value than the value of the saturated steam pressure of the hydrogen or deuterium or of a mixture of the two at the first cryogenic temperature, so as to respectively condense a solid film of hydrogen and/or deuterium or of a mixture of the two on the strip in movement in said volume of the cell.

2. The device according to claim 1, wherein the first heat exchanger is configured to be in contact with a main surface of the strip.

3. The device according to claim 1, wherein the first heat exchanger and the cell are configured to be in contact with a first main surface of the strip in said volume of the cell, so as to achieve condensation of the hydrogen or deuterium or of the mixture of the two on a second surface only, the second surface being opposite to the first main surface of the strip.

4. The device according to claim 1, wherein the first heat exchanger is configured to be in contact with a main surface of the strip, the device comprising at least one spring mechanically connected to a fixed support, the at least one spring being configured so as to fix the tension of the strip and a contact pressure of the strip on the first heat exchanger in said volume of the cell.

5. The device according to claim 1, wherein the cell comprises:
an upstream duct arranged between the first opening and the first heat exchanger, the strip passing through the upstream duct;
a second heat exchanger configured to maintain the strip in the upstream duct at a second temperature that is higher than the first temperature, the second temperature being fixed so as to maintain the hydrogen or deuterium or the mixture of the two in gas phase in the upstream duct.

6. The device according to claim 5, wherein the cell and the upstream duct being arranged for the strip to be devoid of contact with the second heat exchanger, and the upstream duct is connected to said volume of the cell so as to form a first outlet opening of the non-condensed gas on the strip in the said volume.

7. The device according to claim 5, further comprising a first pump configured to perform suction of the non-condensed gas flowing in the upstream duct.

8. The device according to claim 1, comprising:
a downstream duct arranged between the second opening and the first heat exchanger, the strip passing through the downstream duct;
a third heat exchanger configured to maintain the strip in the downstream duct at a third temperature that is higher than the first cryogenic temperature, the third temperature being fixed so as to maintain the hydrogen or deuterium in gas phase in the downstream duct.

9. The device according to claim 8, wherein the cell and the downstream duct are configured for the strip to be devoid of contact with the third heat exchanger, and the downstream duct is connected to said volume of the cell so as to form a second outlet opening of the non-condensed gas on the strip in the said volume.

10. The device according to claim 8, further comprising a second pump configured to perform suction of the non-condensed gas flowing in the downstream duct.

11. The device according to claim 1, comprising a heat shield covering the cell, the heat shield comprising two apertures facing respectively the first and second openings and configured to let the strip moving through the cell via the first and second openings.

12. The device according to claim 1, comprising a tightly sealed cryostat inside which the cell and strip are located, the cryostat comprising:
a first window configured to let an incident laser beam bombarding the strip pass;
a second window configured to let the proton or neutron beam transmitted by the strip pass;
an additional pump configured to create a vacuum in the sealed cryostat.

13. A method for performing continuous deposition of a solid film of hydrogen or deuterium or of a mixture of the two using a device according to claim 1, the method comprising the following steps:
running a strip through a cell from a first opening to a second opening;
injecting a gas formed by hydrogen or deuterium or a mixture of the two into the cell, the strip being maintained in a volume of the cell at a first cryogenic temperature, and the gas being at a first pressure in the cell, said first pressure being adjusted to a first value lower than the saturated steam pressure of the gas at the first temperature;
increasing the first pressure of the gas in said volume of the cell from the first value to a second pressure value that is higher than the saturated steam pressure of the gas at the first temperature.
